(19) United States
(12) Patent Application Publication
(10) Pub. No.: US 2005/0226477 A1
(43) Pub. Date: Oct. 13, 2005

(54) Direction indicating device and direction indicating method

(75) Inventor: Hideki Tanaka, Mukoh-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/090,953

(22) Filed: Mar. 25, 2005

(30) Foreign Application Priority Data
Apr. 9, 2004 (JP) 2004-114916

(51) Int. Cl. G06K 9/00

(52) U.S. Cl. 382/124

(57) ABSTRACT

A direction indicating device includes a fingerprint input unit, a fingerprint registration unit, a fingerprint authentication unit and a control unit. The fingerprint input unit inputs a fingerprint of a finger by being touched with the finger. The fingerprint registration unit registers a fingerprint previously as a standard fingerprint. The fingerprint authentication unit detects a matching part of the input fingerprint input from the fingerprint input unit and the standard fingerprint registered previously in the fingerprint registration unit by being associated with the input fingerprint by comparing the input fingerprint and the standard fingerprint. The control unit determines an indicating direction in accordance with a detection result of the fingerprint authentication unit.

### BACKGROUND OF THE INVENTION

1. Field of the Invention

The present invention relates to a direction indicating device and a direction indicating method for indicating a moving direction of a pointer or the like by using a fingerprint authentication.

2. Description of Related Art

In a mobile information terminal such as a mobile telephone, as a pointing device for moving a pointer (cursor) on a display screen, for example, a pointing device is disposed on an outer case of the mobile information terminal. The pointing device includes a finger plate, an image pickup device, a light condenser lens and a light emitting device. The pointing device takes an image of a pattern (for example, a fingerprint of a fingertip) placed on a surface of the finger plate by the image pickup device. While touching the surface of the finger plate with the fingertip, when the fingertip is moved, an image taken by the image pickup device changes accompanying the movement of the fingertip. The pointer displayed on the display screen moves in a direction according to a direction in which the image changed. In this case, a moving distance of the pointer is a distance according to an amount of the change in the image on the finger plate.

In a known device, a camera unit and a Light Emitting Diode (LED) are provided in an inner space of at least one key (a home position key) of a keyboard of a personal computer or the like. The camera unit takes an image of a fingerprint of an index finger placed on the key. The LED illuminates the fingerprint placed on the key. In the known device, when the index finger placed on the key is moved, a direction of the movement and an amount of the movement are detected. Then, in accordance with movement vector information obtained from the detected direction of the movement and the detected amount of the movement, the pointer is moved.

However, in the pointing device provided in the mobile information terminal, to move the pointer, a fingertip is required to be moved while touching the finger plate. Therefore, in case the display screen is large and the pointer cannot be moved to a desired position by one movement of the fingertip, the fingertip is required to be moved repeatedly in the same direction on the finger plate. In this case, a process to remove the fingertip once from the finger plate, to touch the finger plate again with the fingertip and to move the fingertip while touching the finger plate is required to be repeated. On the contrary, to move the pointer to a desired position by one movement of the fingertip, the size of the finger plate is required to be enlarged. However, the mobile information terminal such as a mobile telephone has a limited space and does not have a sufficient space to enlarge the finger plate. If a large finger plate is provided, the mobile information terminal cannot be downsized or thinned. Such a drawback also exists in a device in which a camera unit and a LED are provided in an inner space of the key.

### SUMMARY OF THE INVENTION

The present invention has been made in consideration of the above-described drawback. An advantage of the present invention is to provide a direction indicating device and a direction indicating method which can easily and reliably carry out a direction indication while being space-saving as much as possible.

According to an aspect of the present invention, a direction indicating device includes a fingerprint input unit, a fingerprint registration unit, a fingerprint authentication unit and a control unit. The fingerprint input unit inputs a fingerprint of a finger by being touched with the finger. The fingerprint registration unit registers a fingerprint previously as a standard fingerprint. The fingerprint authentication unit detects a matching part of the input fingerprint input from the fingerprint input unit and the standard fingerprint registered previously in the fingerprint registration unit by being associated with the input fingerprint by comparing the input fingerprint and the standard fingerprint. The control unit determines an indicating direction in accordance with a detection result of the fingerprint authentication unit.

The direction indicating device determines the indicating direction by using a fingerprint authentication function. That is, the fingerprint authentication unit detects a matching part of the input fingerprint and the standard fingerprint associated with the input fingerprint by comparing the input fingerprint and the standard fingerprint, and determines the indicating direction in accordance with the detection result of the fingerprint authentication unit.

According to another aspect of the present invention, in the direction indicating device, the control unit determines the indicating direction in accordance with a detection result of a presence or absence detecting process and a matching part detecting process. In the presence or absence detecting process, a detection is carried out for whether or not the input fingerprint is the standard fingerprint registered in the fingerprint registration unit. In other words, a detection is carried out for whether or not the input fingerprint exists in the standard fingerprint registered in the fingerprint registration unit. In the matching part detecting process, by using a general fingerprint authentication function that verifies the input fingerprint with the standard fingerprint, in the verification of the input fingerprint and the standard fingerprint that is carried out at a fingerprint authentication, a detection is carried out for which part of the input fingerprint and the standard fingerprint match with one another. Accordingly, it becomes unnecessary to move the finger while touching a finger authentication sensor (a finger plate or a key) as in a conventional art. As a result, the direction indication can be carried out easily and reliably while being space-saving.

According to another aspect of the present invention, for determining the indicating direction in accordance with the detection result of the matching part of the input fingerprint and the standard fingerprint, the control unit is preferable to detect a changing direction of the matching part of the input fingerprint and the standard fingerprint and to make the changing direction as the indicating direction of the finger.

According to another aspect of the present invention, in case the matching part of the input fingerprint and the standard fingerprint is located at a center part of both of the fingerprints, the control unit is preferable to determine a presence or an absence of a click input in accordance with an increase or a decrease in an area of the matching part.

According to another aspect of the present invention, the direction indicating device further includes a display unit which can display a pointer (cursor). The control unit is preferable to control the moving direction of the pointer according to the determined indicating direction.

### BRIEF DESCRIPTION OF THE SEVERAL VIEWS OF THE DRAWINGS

FIG. 1 is a block diagram showing an example of a configuration of a mobile information terminal having a direction indicating device according to an embodiment of the present invention.

FIG. 2 is a schematic plan view of a mobile telephone as an example of the mobile information terminal.

FIG. 3 shows a principle for determining an indicating direction by using a pointing device unit in the mobile information terminal.

FIG. 4 is a flowchart showing an operation relating to a direction indication of the mobile information terminal.

### DETAILED DESCRIPTION OF THE INVENTION

An embodiment of the present invention will be described.

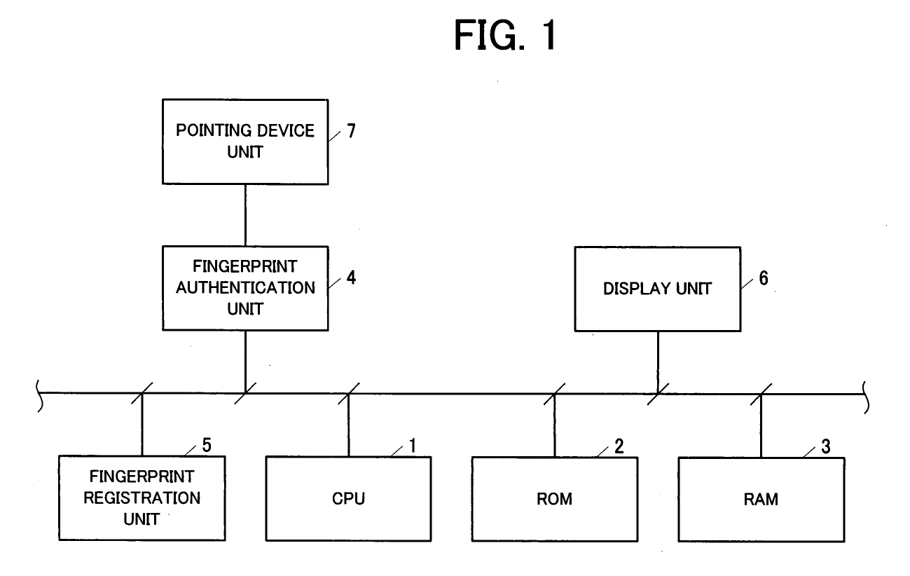

FIG. 1 is a block diagram showing an example of a configuration of a mobile information terminal having a direction indicating device according to an embodiment of the present invention. The mobile information terminal includes a Central Processing Unit (CPU) (a control unit) 1, a Read Only Memory (ROM) 2, a Random Access Memory (RAM) 3, a fingerprint authentication unit 4, a fingerprint registration unit 5, a display unit 6 and a pointing device unit (a fingerprint input unit) 7.

The control unit 1 integrally controls each component of the mobile information terminal in accordance with a program stored in the ROM 2. The control unit 1 has a function for determining an indicating direction in accordance with a detection result of the fingerprint authentication unit 4.

The ROM 2 stores a program or the like for controlling an operation of the entire mobile information terminal. The RAM 3 stores, for example, data necessary for the control operation of the control unit 1 and data necessary to be stored temporarily at the control operation.

The fingerprint authentication unit 4 includes a fingerprint reading function and a matching part detecting function. The fingerprint reading function is a function for reading a fingerprint of a finger placed on a standard area 20 of the pointing device unit 7. The matching part detecting function is a function for comparing an input fingerprint and a standard fingerprint and detecting a matching part of the input fingerprint and the standard fingerprint. The input fingerprint is fingerprint information obtained by reading a fingerprint by the fingerprint reading function. The standard fingerprint is a fingerprint registered previously in the fingerprint registration unit 5 by being associated with the input fingerprint. The fingerprint registration unit 5 previously registers fingerprint information of any finger (for example, an index finger) of a user as a standard fingerprint. The fingerprint information to be registered in the fingerprint registration unit 5 can be input by using the pointing device unit 7.

The display unit 6 displays various images and various characters. The display unit 6 displays a pointer that designates any position in an image. For example, a Liquid Crystal Display (LCD) or an Electro-Luminescence Display (ELD) is used for the display unit 6. The pointing device unit 7 is a fingerprint input unit which inputs fingerprint information of a fingertip by being touched with a finger (fingertip). The pointing device unit 7 functions as both a sensor for a fingerprint authentication to identify a user and a sensor for a direction indication.

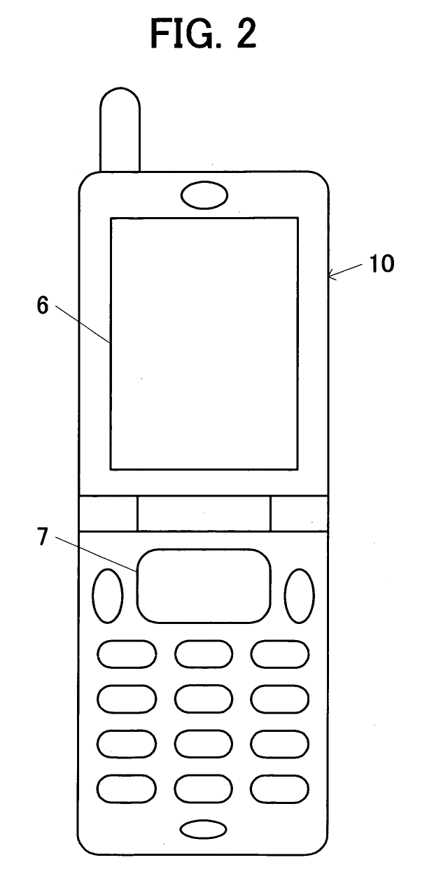

A mobile telephone 10 shown in FIG. 2 is an example of the above-described mobile information terminal. The mobile telephone 10 of FIG. 2 includes the display unit 6 and the pointing device unit 7. As described above, the sensor for the fingerprint authentication to identify a user also functions as the sensor for the direction indication.

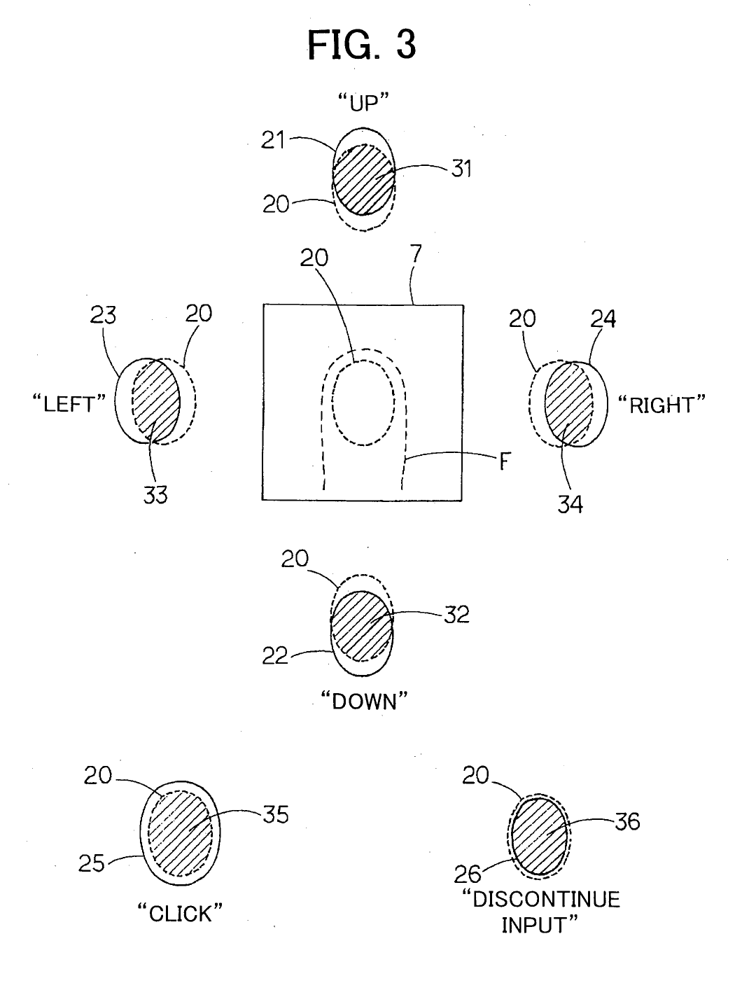

Next, referring to FIG. 3, a description will be made of a principle for determining an indicating direction by using the pointing device unit 7 in such a mobile information terminal.

In the pointing device unit 7 shown in FIG. 3, an area near the center is a standard area 20 to be touched with a fingertip F (an area surrounded by dashed lines). By touching the standard area 20 with the fingertip F, fingerprint information is input. The position of the standard area 20 can be shown with dashed lines in the pointing device unit 7 so that the standard area 20 can be recognized easily by the user.

For carrying out a direction indication, when the user touches the standard area 20 of the pointing device unit 7 with the fingertip F, the fingerprint of the fingertip F is read and fingerprint information is input. Next, the input fingerprint and the standard fingerprint associated with the input fingerprint are compared and a matching part of the input fingerprint and the standard fingerprint is detected. The standard fingerprint is previously registered in the fingerprint registration unit 5. A detection of the matching part of the input fingerprint and the standard fingerprint is carried out as follows.

First, when the user touches the standard area 20 with the fingertip F, the input fingerprint and the standard fingerprint are compared and a matching part of the input fingerprint and the standard fingerprint is detected. That is, a position of the matching part of the input fingerprint and the standard fingerprint on the pointing device unit 7 is detected. Next, from a state in which the user is touching the standard area 20 with the fingertip F, when the user slightly moves the fingertip F in either direction of up, down, left or right, the position of the matching part of the input fingerprint of the fingertip F and the standard fingerprint changes. For example, when the fingertip F touching the standard area 20 is moved upward, in other words, when the fingertip F is tilted upward while touching the pointing device unit 7, a contact area 21 (an area surrounded by a solid line) of the pointing device unit 7 and the fingertip F moves upward. Accordingly, an overlapping part 31 (a matching part of the input fingerprint and the standard fingerprint) (a shaded area) of the standard area 20 and the contact area 21 becomes as shown in “UP” of FIG. 3.

That is, the contact area 21 is initially located at approximately the same position as the standard area 20, and the input fingerprint and the standard fingerprint matched one another over approximately the entire standard area 20. However, by moving the fingertip F upward, the overlapping part 31 changes to be located leaning upward in the standard area 20. The changing direction of the overlapping part 31 is detected, and an “UP” direction, which is the changing direction, is made as an indicating direction of the fingertip F.

In the same manner, for example, when the fingertip F touching the standard area 20 is moved leftward, in other words, when the fingertip F is tilted leftward while touching the pointing device unit 7, a contact area 23 of the pointing device unit 7 and the fingertip F moves leftward. Then, an overlapping part 33 of the standard area 20 and the contact area 23 becomes as shown in “LEFT” of FIG. 3. Accordingly, the overlapping part 33 changes to be located leaning leftward in the standard area 20. The changing direction of the overlapping part 33 is detected, and a “LEFT” direction, which is the changing direction, is made as an indicating direction of the fingertip F.

When the fingertip F is moved downward or rightward, in other words, when the fingertip F is tilted downward or rightward while touching the pointing device unit 7, in the same manner, each of overlapping parts 32 and 34 changes to be located leaning downward or rightward in the standard area 20. Therefore, a “DOWN” direction or a “RIGHT” direction is made as an indicating direction of the fingertip F.

Meanwhile, in case the fingertip F is not moved in either direction of up, down, left or right while touching the standard area 20, the matching part of the input fingerprint and the standard fingerprint becomes the center part of both of the fingerprints. That is, the position of the overlapping part of the standard area 20 and the contact area does not change. In this case, a presence or an absence of a click input is determined in accordance with an increase or a decrease in an area of the matching part of both of the fingerprints. Specifically, in case of the presence of the click input, a determination of “CLICK” shown in a lower-left part of FIG. 3 is made. In case of the absence of the click input, a determination of “DISCONTINUE INPUT” shown in a lower-right part of FIG. 3 is made.

The presence of the click input is a case in which while the matching part of the input fingerprint and the standard fingerprint is maintained at the center part of both of the fingerprints, an area of the matching part increases or decreases. Specifically, while the matching part of both of the fingerprints is maintained at the center part, in case the area of the matching part changes to increase, a determination is made that a pushing operation of the click input has been carried out (a state shown in the lower-left part of FIG. 3 and a state in which the contact area 25 becomes larger than the standard area 20). While the matching part of both of the fingerprints is maintained at the center part, in case the area of the matching part changes to decrease, a determination is made that a releasing operation of the pushing operation has been carried out. That is, while the matching part of both of the fingerprints is maintained at the center part, when the area of the matching part changes to increase and then changes to decrease, a determination is made that one click input has been carried out.

When determining whether or not the area of the matching part of the input fingerprint and the standard fingerprint has changed (increased or decreased), a determination is made as to whether or not the area has changed for a prescribed amount or more. That is, only in case the area changes for a prescribed amount or more, a determination is made that the area has increased or decreased. In case the change in the area does not reach the prescribed amount, a determination is not made that the area has increased or decreased. Therefore, an error input (a misconception of the presence or the absence of the click input) can be prevented. Further, for the determination of the increase or the decrease in the area of the matching part, a time standard can be included. That is, a determination can be made as to whether or not the area of the prescribed amount or more has increased or decreased within a prescribed period of time.

The absence of the click input is a case in which while the matching part of the input fingerprint and the standard fingerprint is maintained at the center part of both of the fingerprints, the area of the matching part does not change (increase or decrease). In this case, a determination is made that the fingertip F is just touching the standard area 20 and none of the directions of up, down, left and right has been indicated (a state shown in the lower-right part of FIG. 3 and a state in which the contact area 26 is approximately the same as the standard area 20). That is, a determination is made that a direction indication or a click has not been carried out at all.

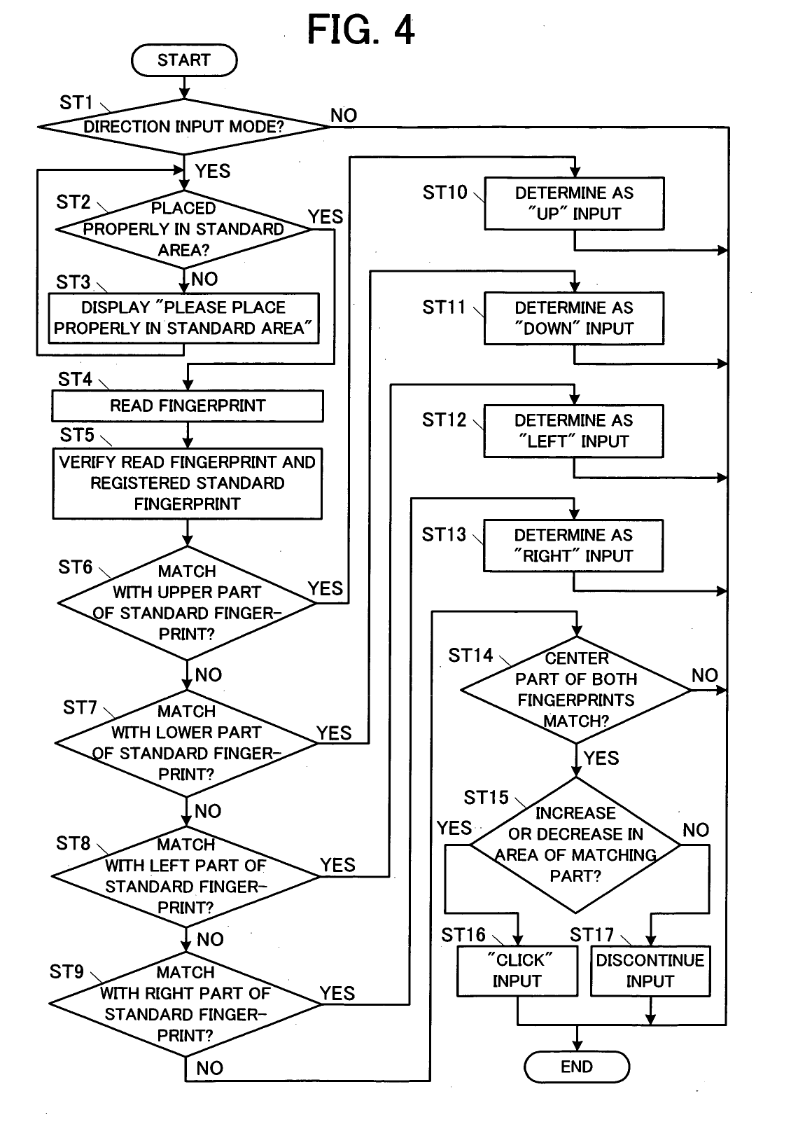

Next, referring to the flowchart of FIG. 4, a description will be made of an operation relating to a direction indication of the mobile information terminal adopting the above-described principle for determining the indicating direction. The mobile information terminal includes a fingerprint authentication mode and a direction input mode. According to the fingerprint authentication mode, a determination is made as to whether or not the input fingerprint is a standard fingerprint registered in the fingerprint registration unit 5. In other words, a determination is made as to whether or not the input fingerprint exists in the standard fingerprint registered in the fingerprint registration unit 5. According to the direction input mode, the indicating direction is determined by using the fingerprint authentication function as described above. The fingerprint authentication mode and the direction input mode are provided capable of being switched by a key or the like. Furthermore, prior to the use of the mobile information terminal, the user registers previously in the fingerprint registration unit 5 via the pointing device unit 7, fingerprint information of any fingertip (for example, a fingertip of an index finger)

At step ST1, a determination is made as to whether or not the mobile information terminal is under a direction input mode. In case the mobile information terminal is not under the direction input mode, the process ends. Meanwhile, in case the mobile information terminal is under the direction input mode, at step ST2, as described above, a determination is made as to whether or not the fingertip F is placed properly in the standard area 20 of the pointing device unit 7. In case the fingertip F is not placed properly, at step ST3, for example, the display unit 6 displays a message, “Please place properly in standard area”. Until the fingertip F is placed properly, the processes of steps ST2 and ST3 are repeated.

In case the fingertip F is placed properly in the standard area 20, at step ST4, the fingerprint authentication unit 4 reads the fingerprint of the fingertip F placed in the standard area 20. Next, at step ST5, the input fingerprint (the read fingerprint) and the standard fingerprint, which is registered previously in the fingerprint registration unit 5 by being associated with the input fingerprint, are verified and a matching part of the input fingerprint and the standard fingerprint is detected. The matching part of the input fingerprint and the standard fingerprint is as described above.

Based on a result of the detection at step ST5, a determination is made on the matching part of the input fingerprint and the standard fingerprint at step ST6, as to whether or not the input fingerprint matches with an upper part of the standard fingerprint (whether or not the overlapping part is located in the upper part of the standard area 20). In case it is determined YES, at step ST10, a determination is made that an “UP” input has been made. That is, since the overlapping part 31 has changed to be located leaning upward in the standard area 20, the “UP” direction, which is the changing direction of the overlapping part 31, is made as an indicating direction of the fingertip F and the process ends.

In case it is determined NO at step ST6, a determination is made at step ST7 as to whether or not the input fingerprint matches with a lower part of the standard fingerprint (whether or not the overlapping part is located in the lower part of the standard area 20). In case it is determined YES, at step ST11, a determination is made that a “DOWN” input has been made. That is, since the overlapping part 32 has changed to be located leaning downward in the standard area 20, the “DOWN” direction, which is the changing direction of the overlapping part 32, is made as an indicating direction of the fingertip F and the process ends.

In case it is determined NO at step ST7, a determination is made at step ST8 as to whether or not the input fingerprint matches with a left part of the standard fingerprint (whether or not the overlapping part is located in the left part of the standard area 20). In case it is determined YES, at step ST12, a determination is made that a “LEFT” input has been made. That is, since the overlapping part 33 has changed to be located leaning leftward in the standard area 20, the “LEFT” direction, which is the changing direction of the overlapping part 33, is made as an indicating direction of the fingertip F and the process ends.

In case it is determined NO at step ST8, a determination is made at step ST9 as to whether or not the input fingerprint matches with a right part of the standard fingerprint (whether or not the overlapping part is located in the right part of the standard area 20). In case it is determined YES, at step ST13, a determination is made that a “RIGHT” input has been made. That is, since the overlapping part 34 has changed to be located leaning rightward in the standard area 20, the “RIGHT” direction, which is the changing direction of the overlapping part 34, is made as an indicating direction of the fingertip F and the process ends.

In case it is determined NO at step ST9, a determination is made at step ST14 as to whether or not the matching part of the input fingerprint and the standard fingerprint is located at the center part of both of the fingerprints (whether or not the overlapping part has not changed). In case it is determined NO, the process ends.

In case it is determined YES at step ST14, a determination is made at step ST15 as to whether or not the area of the matching part of both of the fingerprints has increased or decreased. In case the area has increased or decreased, a determination is made at step ST16 that a “click” input has been made. That is, while the matching part of the input fingerprint and the standard fingerprint is maintained at the center part of both of the fingerprints, in case the area of the matching part changes to increase and then changes to decrease, a determination is made that one click input has been made and the process ends.

Meanwhile, in case the area of the matching part does not increase or decrease, at step ST17, a determination is made to “discontinue input”. That is, while the matching part of the input fingerprint and the standard fingerprint is maintained at the center part of both of the fingerprints, in case the area of the matching part does not change (increase or decrease), a determination is made that the fingertip F is just touching the standard area 20 and the process ends. In this case, neither a direction indication nor a click is carried out.

Specifically, in the mobile telephone 10 shown in FIG. 2, the indicating direction determined by the above-described process shown in the flowchart of FIG. 4, is used for moving a pointer displayed on the display unit 6. For example, in the flowchart of FIG. 4, in case a determination is made that an “UP” input has been made (step ST10), the pointer is moved upward from a current position. In case a determination is made that a “LEFT” input has been made (step ST12), the pointer is moved leftward from the current position. In case a determination is made that a “click” input has been made (step ST16), a position currently indicated by the pointer is fixed. That is, when the pointer is indicating a menu, the indicated menu is selected and fixed. In case a determination is made to “discontinue input”, a standby state is maintained while stopping the pointer at the current position.

According to a period of time when the fingertip F is maintained under a moving state, a moving speed and/or a moving amount of the pointer are controlled. That is, by canceling the moving state (a tilting state of the fingertip F) and returning to the original state (a state in which the matching part is located at the center), the movement of the pointer can be stopped. In this case, in case the fingertip F is moved in the indicating direction for a prescribed period of time or longer (for example, two to three seconds), in other words, in case the fingertip F is maintained under the moving state in the same direction for a prescribed period of time or longer, the pointer can be moved continuously at a high speed. Accordingly, the pointer can be moved promptly to a target position. In case duration of the moving state of the fingertip F is shorter than a prescribed period of time, the pointer can be moved by a unit amount. That is, by repeating a process to put the fingertip F under the moving state and then to return the fingerprint F to the original state before a prescribed period of time elapses, the pointer can be moved per unit amount. Accordingly, after the pointer reaches close to the target position, the pointer can be moved little by little and the position of the pointer can be fixed.

In the above-described embodiment, the indicating direction is four directions, i.e., “UP”, “DOWN”, “LEFT” and “RIGHT”. However, “UPPER LEFT”, “UPPER RIGHT”, “LOWER LEFT” and “LOWER RIGHT” can be added and the indicating direction can be eight directions. The indicating direction of “UPPER LEFT”, “UPPER RIGHT”, “LOWER LEFT” and “LOWER RIGHT” can be determined in accordance with the same principle as described above.

1. A direction indicating device, comprising:
a fingerprint input unit which is touched with a finger and inputs a fingerprint of the finger;
a fingerprint registration unit in which a fingerprint is registered previously as a standard fingerprint;
a fingerprint authentication unit which detects a matching part of an input fingerprint input from the fingerprint input unit and a standard fingerprint registered previously in the fingerprint registration unit by comparing the input fingerprint and the standard fingerprint; and
a control unit which determines an indicating direction in accordance with a detection result of the fingerprint authentication unit.

2. The direction indicating device according to claim 1, wherein the control unit detects a changing direction of the matching part of the input fingerprint and the standard fingerprint and the changing direction is made as an indicating direction of the finger.

3. The direction indicating device according to claim 1, wherein in case the matching part of the input fingerprint and the standard fingerprint is a center part of both of the fingerprints, the control unit determines a presence or an absence of a click input in accordance with an increase or a decrease in an area of the matching part.

4. The direction indicating device according to claim 3, wherein in case the matching part of the input fingerprint and the standard fingerprint is the center part of both of the fingerprints, when the area of the matching part changes to increase and then changes to decrease, the control unit determines that one click input has been made.

5. The direction indicating device according to claim 3, wherein the control unit determines whether the area of the matching part of the input fingerprint and the standard fingerprint has changed for a prescribed amount or more, and in case the area of the matching part has changed for the prescribed amount or more, the control unit determines that the area has increased or decreased.

6. The direction indicating device according to claim 3, wherein in case the area of the matching part of the input fingerprint and the standard fingerprint changes for a prescribed amount or more within a prescribed period of time, the control unit determines that the area has increased or decreased.

7. The direction indicating device according to claim 3, wherein while the matching part of the input fingerprint and the standard fingerprint is maintained at the center part of both of the fingerprints, in case the area of the matching part does not increase or decrease, the control unit determines that the click input and a direction indication have not been carried out.

8. The direction indicating device according to claim 1, further comprising a display unit which displays a pointer, wherein the control unit controls a moving direction of the pointer according to the determined indicating direction.

9. The direction indicating device according to claim 1, wherein the control unit controls a moving speed and/or a moving amount in the indicating direction according to a period of time when the matching part of the input fingerprint and the standard fingerprint is under a moving state.

10. The direction indicating device according to claim 9, wherein in case the matching part of the input fingerprint and the standard fingerprint is under the moving state for a prescribed period of time or longer, the control unit switches the moving speed in the indicating direction to a high speed.

11. The direction indicating device according to claim 10, wherein in case the moving state of the matching part of the input fingerprint and the standard fingerprint ends within the prescribed period of time, the control unit makes the moving amount in the indicating direction as a unit amount.

12. A direction indicating method, comprising:
a fingerprint inputting step of inputting a fingerprint of a finger by touching with the finger;
a fingerprint registering step of registering a fingerprint previously as a standard fingerprint;
a fingerprint authenticating step of detecting a matching part of an input fingerprint input at the fingerprint inputting step and the standard fingerprint registered previously at the fingerprint registering step by being associated with the input fingerprint by comparing the input fingerprint and the standard fingerprint; and
a determining step of determining an indicating direction in accordance with a detection result at the fingerprint authenticating step.

13. The direction indicating method according to claim 12, wherein at the determining step, a changing direction of the matching part of the input fingerprint and the standard fingerprint is detected and the changing direction is determined as an indicating direction of the finger.

14. The direction indicating method according to claim 12, wherein in case the matching part of the input fingerprint and the standard fingerprint is located at a center part of both of the fingerprints, a presence or an absence of a click input is determined in accordance with an increase or a decrease in an area of the matching part.

15. The direction indicating method according to claim 14, wherein at the determining step, while the matching part of the input fingerprint and the standard fingerprint is maintained at the center part, in case the area of the matching part does not increase or decrease, a determination is made that the click input and a direction indication have not been carried out.

16. The direction indicating method according to claim 12, further comprising a moving step of controlling a moving direction of a displayed pointer according to the indicating direction determined at the determining step.

17. The direction indicating method according to claim 16, wherein at the moving step, a moving speed and/or a moving amount in the indicating direction are controlled according to a period of time when the matching part of the input fingerprint and the standard fingerprint is under a moving state.

18. The direction indicating method according to claim 17, wherein at the moving step, in case the matching part of the input fingerprint and the standard fingerprint is under the moving state for a prescribed period of time or longer, the moving speed in the indicating direction is switched to a high speed.

19. The direction indicating method according to claim 17, wherein at the moving step, in case the moving state of the matching part of the input fingerprint and the standard fingerprint ends within a prescribed period of time, the moving amount in the indicating direction is made as a unit amount.

20. A direction indicating method, comprising:
a fingerprint inputting step of inputting a fingerprint of a finger by touching with the finger;
a fingerprint registering step of registering a fingerprint previously as a standard fingerprint;
a tilt detecting step of detecting a tilt of the finger by comparing the input fingerprint input at the fingerprint inputting step and the standard fingerprint registered previously at the fingerprint registering step by being associated with the input fingerprint; and
a determining step of determining an indicating direction in accordance with a detection result of the tilt detecting step.
